(19) United States
(12) Patent Application Publication
(10) Pub. No.: US 2009/0211156 A1
(43) Pub. Date: Aug. 27, 2009

(54) ANTI-PINCH DEVICE FOR VEHICLES

(75) Inventor: Josef Appel, Gauting (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Webasto AG, Stockdorf (DE)

(21) Appl. No.: 11/722,142

(22) PCT Filed: Dec. 2, 2005
(86) PCT No.: PCT/DE05/02185

§ 371 Date: Mar. 16, 2009

(30) Foreign Application Priority Data
Dec. 21, 2004 (DE) 10 2004 061 578.0

(51) Int. Cl. E05F 15/00

(52) U.S. Cl. 49/28; 701/45

(57) ABSTRACT

Anti-pinching means for vehicles with at least two sensor arrangements (16, 16n, 17, 17n) for detecting the danger of pinching by at least one vehicle part (10, 10a, 10b) which can be moved by a driving means (12, 13, 14, 14a, 14b), and for delivery of pinching danger signals to an evaluation means (18) which is assigned jointly to the two sensor arrangements. The evaluation device (18) is designed such that it switches the driving means into an operating mode which prevents pinching via a drive control (15) when the pinching danger signals of the two sensor arrangements differ by a predetermined minimum value from one another.

### BACKGROUND OF THE INVENTION

1. Field of Invention

The invention relates to an anti-pinching means for vehicles for prevention of pinching of foreign bodies, especially endangered body parts of vehicle passengers, by vehicle parts which can be moved by a motor.

2. Description of Related Art

Anti-pinching means are known in various executions. For example, German Patent Application DE 35 27 405 A1 discloses a means for protecting against pinching in vehicle openings which can be closed by a motor, in which there is a sensor in the form of an electrode which is located on the closing edge of the opening and which extends over the length of the closing edge and is part of a capacitive detector which delivers a control signal for turning off the drive of the closing element for incipient pinching.

Anti-pinching means of this type are exposed to influences which have nothing to do with the danger of pinching and can cause faulty triggering. These influences include, especially, tolerance-dictated changes of distance and ambient effects, such as moisture and precipitation. Attempts have been made to counteract them by the working point (i.e., the triggering threshold) of the anti-pinching means being tracked accordingly on a continuous basis or before the start of movement of the vehicle part. Changes in the capacitance of the capacitive detector which are caused by the movement of the vehicle part itself have been roughly corrected in their typical behavior.

However, it has been found that only slow changes of the ambient conditions can be effectively compensated and either increased risk of faulty triggering must be tolerated or the sensitivity of the system must be reduced accordingly. In addition, hazard situations which may be present even before activation of sensor evaluation can be misinterpreted as altered ambient conditions, and thus, can be masked, if they cannot be detected by plausibility checks. Correction of the influences from inherent motion of the movable vehicle part is not completely successful even with considerable correction effort because, depending on the ambient conditions prevailing at the time different correction, behaviors are necessary for this purpose.

### SUMMARY OF THE INVENTION

The object of the invention is therefore to devise an anti-pinching means for vehicles which, with comparatively low cost, allows reliable detection of the danger of pinching even with changing ambient influences and tolerances which are inevitable in practice.

This object is achieved in accordance with the invention by an anti-pinching means for vehicles with at least two sensor arrangements for detecting the danger of pinching by at least one vehicle part which can be moved by a driving means, and for delivery of pinching danger signals to an evaluation means which is assigned jointly to the two sensor arrangements and which is designed such that it switches the driving means into an operating mode which prevents pinching via a drive control when the pinching danger signals of the both sensor arrangements differ by a predetermined minimum value from one another.

With the anti-pinching means in accordance with the invention, the circumstance is used that changing ambient conditions and influences which can be attributed to the inherent motion of the adjustable vehicle part/parts act essentially the same on all sensor arrangements, and thus, in the arrangement in accordance with the invention remain unevaluated, while hazard situations are made noticeable in different ways typically at one time on the sensor arrangements and are thus detected.

Preferred configurations of the invention will become apparent from the following descriptions.

In another embodiment of the invention, the driving means can have at least one actuator which is drive-connected to two actuating arrangements which are each assigned to one of two opposite sides of the same movable vehicle part. Preferably, the two actuating arrangements are designed to be at least approximately symmetrical to one another, one of the two sensor arrangements being located on a respective one of the two actuating arrangements.

However, according to a modified configuration of the invention, the driving means can also have two actuators which are drive-connected to at least two actuating arrangements which are each assigned to one of several movable vehicle parts.

At least one movable vehicle part can be designed for alternately closing or at least partially opening of a vehicle opening, and the sensor arrangements can each have a least one capacitive detector.

The evaluation means is advantageously equipped with a comparator for comparing the pinching danger signals of the sensor arrangements.

Embodiments of the invention are explained in detail below with reference to the accompanying drawings.

### BRIEF DESCRIPTION OF THE DRAWINGS

FIG. 1 is a schematic block diagram of a first embodiment of the anti-pinching means in accordance with the invention, and

FIG. 2 is a schematic block diagram of a second embodiment of an anti-pinching means in accordance with the invention.

### DETAILED DESCRIPTION OF THE INVENTION

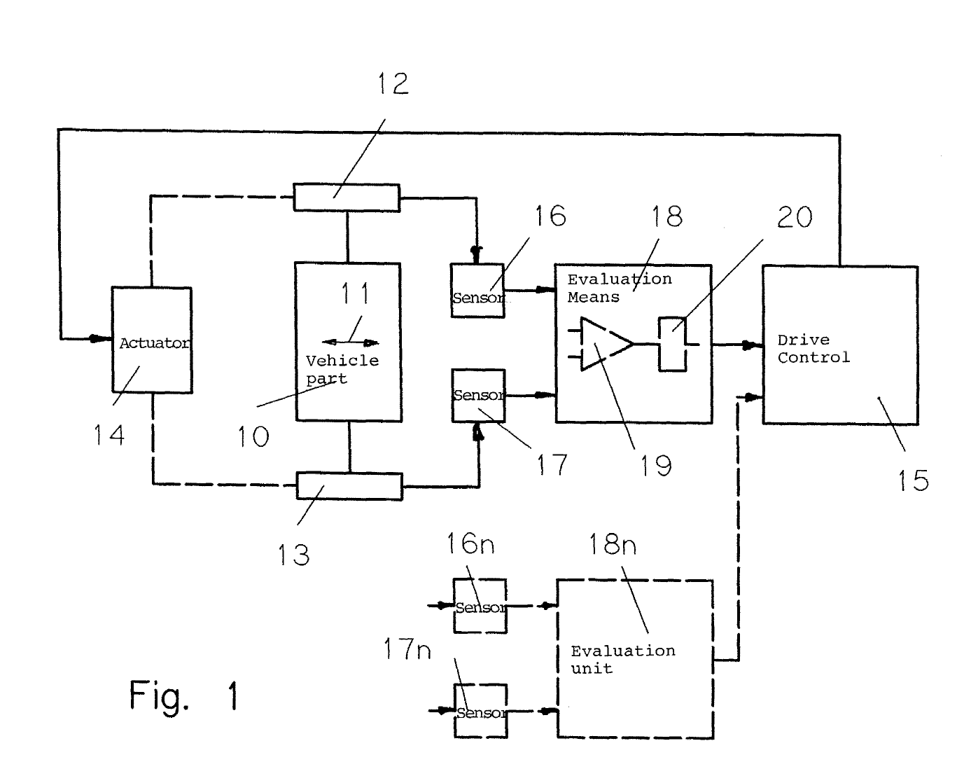

In FIG. 1, a vehicle part 10, for example, the cover of a sliding/lifting roof, is movable in the directions of the double arrow 11 via actuating arrangements 12, 13 which act on opposing sides of the vehicle part 10. The actuating arrangements 12, 13 are, for example, conventional sliding/raising mechanisms, each of which is located on a respective side of the cover 10. The actuating arrangements 12, 13 are actuated by means of a preferably electrical actuator 14 which is under the influence of a drive control 15. The closing movements of the cover 10 which could lead to pinching of endangered body parts are monitored by means of two sensors 16, 17, of which one of which 16 is assigned to the actuating arrangement 12 and the other of which 17 is assigned to the actuating arrangement 13. Between the outputs of the sensors 16, 17 and the signal input of the drive control 15, an evaluation means 18 is connected which, in the illustrated embodiment, contains a comparator 19 and a threshold element 20 which is located downstream from it. The output of the evaluation means 18 is connected to the control input of the drive control 15.

Systematic influences caused by adjustment movements of the vehicle part 10 (for example, of the cover) act like general ambient effects in the same direction on both sensors 16, 17. As a result they lead to equivalent changes of the output signals of the sensors 16, 17 in the same direction. Therefore, they are compensated for in the comparison carried out by means of the comparator 19, and they remain without any effect on the drive control 15 and the actuator 14 because the threshold element 20 does not respond.

Hazard situations, especially incipient pinching of body parts, generally occur at one time and only on one side of the vehicle part 10, or in any case, asymmetrically. As a result, the sensors 16, 17 do not respond equally, so that, in this case, the output signals of the sensors 16, 17 are distinctly different and a danger signal travels via the threshold element 20 to the drive control 15. The actuator is then stopped or reversed by means of the drive control 15.

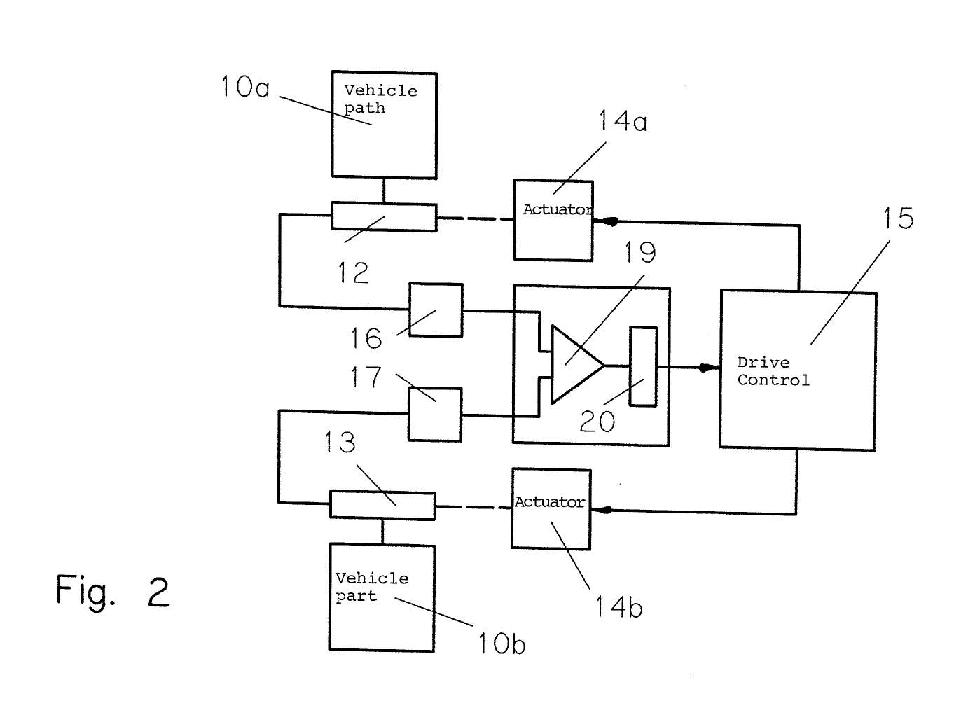

The anti-pinching means which is shown in FIG. 2 differs from that of FIG. 1 only in that the drive control 15 triggers two actuators 14a, 14b for two vehicle parts 10a, 10b which can be moved at the same time, for example, a pair of retractable front headlights. In this case, the danger of pinching typically occurs only on one side, i.e., either on the vehicle part 10a or vehicle part 10b, and with the above described means, it is clearly differentiated from ambient influences and/or synchronous adjustment movements of the vehicle parts 10a, 10b.

Any number of further sensor pairs 16n, 17n with a downstream evaluation means 18n connected to the drive control 15 can be assigned to the opposing sides of the adjustable vehicle part 10 of FIG. 1 or the adjustable vehicle parts 10a, 10b of FIG. 2.

The sensors 16 to 16n, 17 to 17n, depending on the type of vehicle part 10, can be arranged in pairs, for example, on raising levers, the articulations of folding tops, and other pinching points. They are preferably made as capacitive detectors, although fundamentally any other sensors, such as inductive, infrared, ultrasonic or Hall sensors may be used.

An evaluation circuit 18 can also be implemented in a manner other than the one shown schematically in FIG. 1, for example, using a measurement bridge. Comparison of the output signals of the sensors 16 to 16n, 17 to 17n can take place before—for example, by means of a measurement bridge—, during (for example, with the corresponding instrument transformer) or after—in evaluation software or a hardware comparator as indicated in FIG. 1 at 19—appropriate conditioning of the sensor measurement values.

The explained anti-pinching means is characterized especially by sensitivity to ambient influences which is greatly reduced compared to known arrangements with sensitivity which is maintained or improved at the same time for the actual approach of body parts to sensors. Nevertheless, the anti-pinching means can be built to be relatively simple, durable and reliable.

Currently, conventional correction means can be provided parallel to the above described arrangement in order to eliminate possibly remaining residual errors, for example, caused by small asymmetries, and thus, to further improve the durability of the system.

1-8. (canceled)

9. Anti-pinch device for vehicles, comprising:
a drive control for controlling a driving means for moving at least one movable vehicle part,
at least two sensor arrangements for detecting the danger of pinching by said at least one movable vehicle part, and
an evaluation means assigned jointly to the two sensor arrangements for receiving signals from both of the sensor arrangements and for causing the drive control to switch the driving means into an operating mode which prevents pinching when the pinching danger signals of the two sensor arrangements differ by a predetermined minimum value from one another.

10. Anti-pinch device as claimed in claim 9, wherein at least one drive actuator is drive-connected to two actuating arrangements, each of which is assigned to one of two opposite sides of the same movable vehicle part.

11. Anti-pinch device as claimed in claim 10, wherein the two actuating arrangements are at least approximately symmetrically positioned relative to one another.

12. Anti-pinch device as claimed in claim 10, wherein a respective one of the two sensor arrangements is located on each of the two actuating arrangements.

13. Anti-pinch device as claimed in claim 9, wherein at least two drive actuators are drive-connected to at least two actuating arrangements, each of which is assigned to a respective one of several movable vehicle parts.

14. Anti-pinch device as claimed in claim 9, wherein said at least one movable vehicle part alternately closes and at least partial opens a vehicle opening.

15. Anti-pinch device as claimed in claim 9, wherein each of the sensor arrangements has a least one capacitive detector.

16. Anti-pinch device as claimed in claim 9, wherein the evaluation means has a comparator for comparing pinching danger signals from the sensor arrangements.

17. A vehicle, comprising:
at least one movable vehicle part, and
an anti-pinch device, said anti-pinch device comprising:
a drive control for controlling a driving means for moving said at least one movable vehicle part,
at least two sensor arrangements for detecting the danger of pinching by said at least one movable vehicle part, and
an evaluation means assigned jointly to the two sensor arrangements for receiving signals from both of the sensor arrangements and for causing the drive control to switch the driving means into an operating mode which prevents pinching when the pinching danger signals of the two sensor arrangements differ by a predetermined minimum value from one another.

18. The vehicle as claimed in claim 17, wherein at least one drive actuator is drive-connected to two actuating arrangements, each of which is assigned to one of two opposite sides of the same movable vehicle part.

19. Anti-pinch device as claimed in claim 17, wherein said at least one movable vehicle part alternately closes and at least partial opens a vehicle opening.

20. Anti-pinch device as claimed in claim 9, wherein at least two drive actuators are drive-connected to at least two actuating arrangements, each of which is assigned to a respective one of several movable vehicle parts.
